(19) United States
(12) Patent Application Publication
(10) Pub. No.: US 2021/0189540 A1
(43) Pub. Date: Jun. 24, 2021

(54) APPARATUS FOR TREATING A METAL STRIP

(71) Applicant: Fontaine Engineering und Maschinen GmbH, Langenfeld (DE)

(72) Inventors: Pascal Fontaine, Langenfeld (DE); Dominique Fontaine, Langenfeld (DE); Thomas Daube, Duisburg (DE); Michael Zielenbach, Siegen (DE)

(73) Assignee: Fontaine Engineering und Maschinen GmbH, Langenfeld (DE)

(21) Appl. No.: 16/610,565

(22) PCT Filed: Apr. 11, 2018
(86) PCT No.: PCT/EP2018/059227

§ 371 Date: Nov. 4, 2019

(30) Foreign Application Priority Data
May 4, 2017 (DE) 10 2017 109 559.4

(51) Int. Cl. C23C 2/20; C23C 2/00; C23C 2/40; C23C 2/26; C23C 2/24; C23C 2/06; H01F 7/06

(52) U.S. Cl. CPC C23C 2/20; C23C 2/003; C23C 2/40; H01F 7/06; C23C 2/24; C23C 2/06; C23C 2/26

(57) ABSTRACT

An apparatus for treating a metal strip after it has exited from a coating container with a liquid coating material, for example zinc is provided. The apparatus includes a blow-off device arranged above the coating container having an air outlet gap for blowing off excess parts of the still liquid coating material from the surface of the metal strip after the passing of the metal strip through the coating container. An electromagnetic stabilizer is arranged above the blow-off device and has a plurality of individual magnets for stabilizing the metal strip after leaving the coating container and the blow-off device. In order to further increase the efficiency of the apparatus, at least some of the magnets of the stabilizer are formed as pot magnets with pot coils.

### TECHNICAL FIELD

The disclosure relates to an apparatus for treating a metal strip after it has exited from a coating container with a liquid coating material, for example zinc.

### BACKGROUND

Such apparatuses are generally known in the prior art, for example from the international patent application WO 2012/172648 A1 and the German patent applications DE 10 2009 051 932 A1, DE 10 2007 045 202 A1 and DE 10 2008 039 244 A1, and from the conference contribution entitled “Electromagnetic strip Stabilizer for Hot Dip Galvanizing Lines,” Peter Lofgren et al., held/disclosed at the 97th meeting of the Galvanizers Association, Lexington, Ky., Oct. 16-19, 2005. Specifically, these publications disclose a coating container filled with a liquid coating material. For coating, the metal strip is passed through the container with the coating material. After leaving the coating container, the metal strip passes through a blow-off device or nozzle arranged above the coating container for blowing off excess parts of the still liquid coating material, which adheres to the surface of the metal strip. An electromagnetic stabilizer supported by the blow-off device, also known as a Dynamic Electro-Magnetic Coating Optimizer (DEMCO), is arranged above the blow-off device, to stabilize the strip after leaving the coating container and the blow-off device. The electromagnetic stabilizer generates electromagnetic forces, by which the metal strip is held centrally in a central plane of the entire apparatus; thus, an oscillation of the metal strip during passing through, in particular, the blow-off device is at least reduced.

In practice, however, the disadvantage of these described structures is that the electromagnetic stabilizer is located quite far above the blow-off device. This is disadvantageous in that the stabilizing effect exerted by the stabilizer on the metal strip is only of limited effect on the blow-off device. In addition, the forces to be generated by the stabilizer, which are necessary to stabilize the metal strip in the area of the remote blow-off device, are relatively high in the prior art. Accordingly, the energy required to operate the stabilizer is relatively high. Finally, it is a disadvantage that the stabilizer is located above the nozzle carrier or the traverse, because this makes access to the metal strip in the area of the nozzle carrier considerably more difficult.

This can be remedied by the teaching in accordance with German industrial property rights DE 10 2015 216 721 B3 and DE 20 2015 104 823 U1, which stipulate that the electromagnetic stabilizer must in each case be positioned between the traverse and the blow-off device, and thus even closer to the blow-off device.

It is known from DE 21 37 850 C3 that pot magnets are used for the axially stabilized bearing of a rotating shaft.

### SUMMARY

The invention is based on the object of further developing a well-known apparatus for treating a metal strip in order to further increase the efficiency of the machine.

This object is achieved by the subject matter as claimed. In the case of the apparatus described in the introduction, this is achieved by the fact that at least some of the magnets of the stabilizer are formed as pot magnets with pot coils.

Pot magnets have the advantage that they are much more compact than conventional magnets with horseshoe-shaped iron cores. That is, their external dimensions are significantly smaller than those of other magnets with iron cores when designed to generate a magnetic force of the same magnitude. This in turn offers the advantage that the vertical distance between the stabilizer and the blow-off device can be further reduced, thus further increasing the efficiency of the machine. Nevertheless, the magnet coils have little or no influence on the stripping behavior or the air flow of the blow-off device.

According to a first example, for this purpose, it is advantageous if all magnets of the stabilizer are formed as pot magnets.

According to another exemplary embodiment, a horizontal traverse, also known as a nozzle carrier, is mounted between two vertical uprights. The blow-off device is attached to the traverse, preferably suspended from it below the traverse. The stabilizer is also preferably attached in a manner suspended from the traverse below it, but between the traverse and the blow-off device. The mounting of the stabilizer on the traverse is independent of the attachment of the blow-off device on the traverse.

The arrangement of both the stabilizer and the blow-off device underneath the traverse offers the advantage that the area above the traverse, and thus also a slot spanned by the traverse for the passing through of the metal strip, is very easily accessible for an operator.

By using the pot magnets, a closer arrangement of the stabilizer on the blow-off device is possible at a distance of 100-800 mm, preferably in a distance range of 100-550 mm or further preferably in a distance range of 100-450 mm. Due to the small distance, less force must be generated by the stabilizer to stabilize the metal strip in the area of the blow-off device or nozzle. This also reduces the energy requirement of the stabilizer and makes the apparatus more efficient as a whole.

According to another exemplary embodiment, each magnet is preferably assigned with its own distance sensor for the preferably continuous detection of the distance of the respective magnet from the metal strip. Advantageously, this distance sensor is located in the middle of the coreless hollow pot coil. This offers the advantage that the distance sensors do not take up any additional space next to the magnets within the electromagnetic stabilizer, which in turn makes the stabilizer much more compact as a whole. In addition, the distance sensor in the eye of the pot coil is thermally and mechanically protected. The thermal protection exists because the distance sensor is not exposed to direct heat radiation from the zinc pot. The distance sensor can be formed as an eddy current sensor or as an optical sensor.

The apparatus further comprises a regulating device for regulating the position of the metal strip in the slot of the electromagnetic stabilizer to a predetermined target center position, also known as the fitting line. The regulation takes place according to the distances between the magnets and the metal strip determined by the distance sensors, through the suitable variation of the current through the coils of the magnets. In this respect, the distance sensors in conjunction with the regulating device contribute to the fact that the metal strip can be held in the target center position in the slot of the electromagnetic stabilizer, which in turn contributes advantageously to a more uniform coating thickness on the metal strip.

The individual attachment of the blow-off device and the stabilizer on the traverse is effected via independent displacement devices. In concrete terms, the blow-off device is attached to the traverse via a blow-off displacement device, but can be displaced relative to the traverse. Furthermore, the stabilizer is attached to the traverse via a stabilizer displacement device, but can be displaced relative to the traverse. Not only is the stabilizer as a whole displaceable relative to the traverse, but rather each individual magnet of the electromagnetic stabilizer is assigned with an individual displacement device. This makes it possible for each individual magnet to be attached to the traverse and mounted so that it can be displaced relative to the traverse. Each of the displacement devices enables different degrees of freedom for the movement of the blow-off device and the stabilizer in relation to the central plane of the apparatus and also in relation to the metal strip. The displacements enable in particular the displacement of the blow-off device and the stabilizer relative to each other. In particular, the displacement devices enable the blow-off device, the stabilizer as a whole or, optionally, the individual magnets of the stabilizer to be displaced relative to each other. Furthermore, in particular, each of the displacement devices enables the individual displacement of the individual magnets relative to each other in the width direction of the metal strip; that is, in the longitudinal direction of the traverse.

In addition to the individual degrees of freedom for the respective devices realized by the blow-off displacement device and the stabilizer displacement device, it is advantageous that the traverse, together with the blow-off device and stabilizer attached to it, is mounted in a manner vertically displaceable on the vertical uprights. The vertical uprights together with the traverse can be displaced parallel to each other in the horizontal plane. Since the traverse is mounted on one of the vertical uprights so that it can swivel around a fixed pivot point (fixed side) in the horizontal plane and the traverse is mounted loosely on the other vertical upright (loose side), the swiveling of the traverse in the horizontal plane is also possible. These degrees of freedom of the traverse apply equally to the blow-off device and the stabilizer, because both devices are mounted on the traverse.

With the individual magnets, only tensile forces can be exerted on the strip to pull the metal strip in the direction of the magnets. In order to keep the metal strip in the target center position, it is therefore necessary that the magnets of the stabilizer are arranged on both sides of the metal strip. The tensile forces exerted on the strip by the magnets can then be individually adjusted so that they partly compensate each other or hold the strip in the center position. The possibility of shifting the individual magnets, in particular parallel to the plane of the metal strip, given by the stabilizer displacement device, offers the possibility that compensation can also be provided for the unevenness in the metal strip. A separate control device is provided for this purpose, which device moves the magnets parallel to the plane of the metal strip but possibly also offset to each other on both sides of the metal strip in such a manner that the tensile forces generated by the offset magnets generate bending moments in the metal strip that are formed in such a manner that compensation is provided for wave troughs and wave crests in the metal strip as far as possible. This makes the metal strip flat.

Advantageously, in particular in the case of a coating on both sides of the metal strip, the blow-off device has an air gap on both sides of the metal strip.

Finally, the apparatus may include a collision protection device for retracting the electromagnetic stabilizer, in particular the individual magnets, preferably together with their housings, and preferably also for retracting the blow-off device in the event of a malfunction. The stabilizer and/or the blow-off device is then retracted away from the metal strip, in particular in a direction transverse to the plane of the metal strip, such that the metal strip does not collide with the magnets or sensors. A malfunction is, for example, a strip rupture or the detection that a wrong strip is being coated.

### BRIEF DESCRIPTION OF THE DRAWINGS

FIG. 1 is a plan view of an apparatus for treating a metal strip.

FIG. 2 shows a cross-section of the apparatus as in FIG. 1.

FIG. 3 and FIG. 4 are top views of a slot of a blow-off device and an electromagnetic stabilizer, in each case with a marking of the target center position and various undesirable actual positions of the metal strip.

### DETAILED DESCRIPTION

The invention is described in detail below in the form of exemplary embodiments with reference to the figures mentioned. In all figures, the same technical elements are designated with the same reference signs.

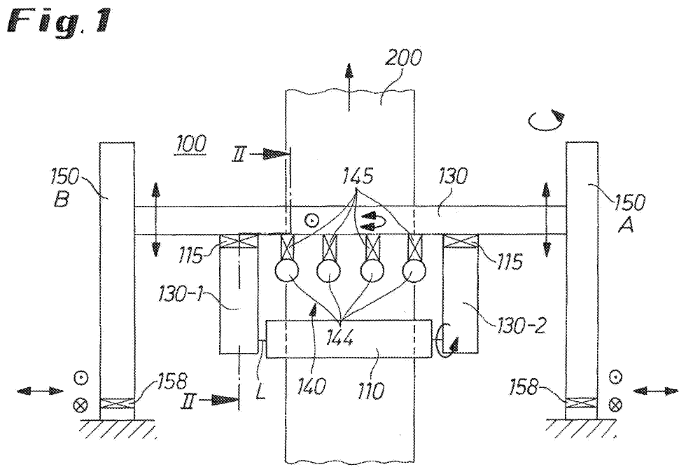

FIG. 1 shows an apparatus 100 for treating a metal strip. It comprises two vertically extending uprights 150 arranged at the sides, on which a traverse 130, also called a nozzle carrier, is mounted so that it can be displaced vertically; see the double arrows in FIG. 1. The apparatus 100 can also be swiveled in the horizontal plane. For this purpose, one of the two uprights 150 is formed as fixed side A, on which the traverse is mounted so that it can swivel around a vertical axis of rotation. The opposite upright, on the other hand, is formed as loose side B and only supports the traverse vertically. Due to this design of the uprights as fixed and loose sides, the apparatus 100 and in particular the traverse 130 can be aligned symmetrically to the metal strip 200 by swiveling it horizontally with the aid of an upright displacement device 158 when the metal strip 200 is at an angle. As a result, the wide sides of the traverse are always to be aligned parallel to the metal strip and both are to have the same distance from it.

A blow-off device 110 or nozzle is suspended from the traverse 130. The coupling of the blow-off device 110 to the traverse 130 does not take place rigidly, but via a blow-off displacement device 115, which is formed to displace the blow-off device 110 relative to the traverse 130 in the horizontal plane; that is, in particular perpendicular to the center plane 160 of the apparatus. In addition, the blow-off displacement device 115 is formed to swivel the blow-off device 110 around its own longitudinal axis L and thus suitably set against the metal strip 200.

Between the traverse 130 and the blow-off device 110, a stabilizer 140, also called Dynamic Electro-Magnetic Coating Optimizer (DEMCO), is attached to the traverse. The stabilizer 140 comprises a plurality of individual magnets 144 on each side of the metal strip. Preferably, all such magnets are formed as pot magnets. Preferably, each of such magnets is fastened individually to the traverse by a stabilizer displacement device 145. Such stabilizer displacement devices 145 enable the individual, translational displacement of each individual magnet in the horizontal plane relative to the traverse; that is, perpendicular and parallel to the center plane 160 of the apparatus 100, in particular in the longitudinal direction of the traverse. In addition, the stabilizer displacement device 145 can also be formed to swivel the stabilizer 140 in the horizontal plane relative to the traverse 130 and relative to the blow-off device 110 around a vertical axis of rotation.

The use of the pot magnets is not limited to the arrangement between the traverse and the blow-off device. Rather, the pot magnets can also be arranged above the traverse.

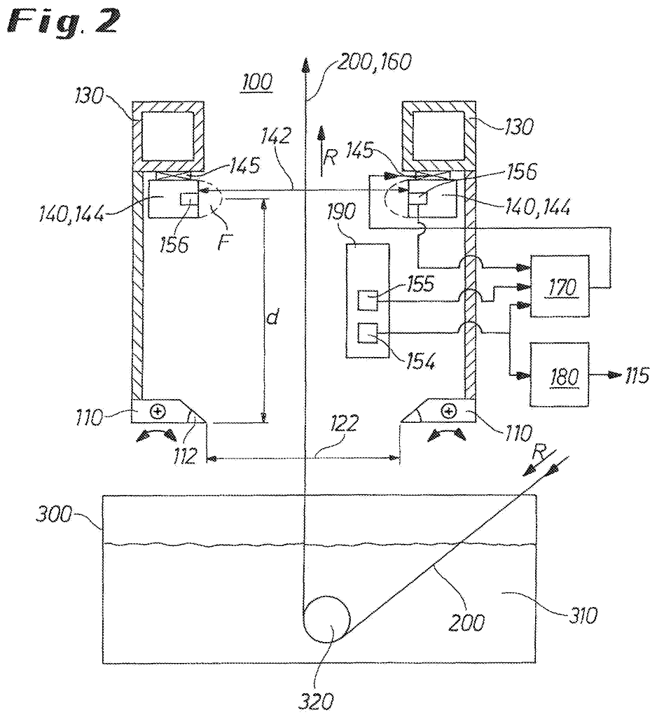

FIG. 2 shows the apparatus from FIG. 1 in a cross-sectional view. The reference sign 170 designates a control device for controlling the stabilizer displacement devices 145. A coating container 300 can be recognized; in principle, this is located below the apparatus 100. The metal strip 200 to be coated is fed in transport direction R into the coating container 300 with the liquid coating material 310 and deflected into the vertical position by a deflection roller 320. It then passes from bottom to top initially through the blow-off device 110 and then through the stabilizer 140. In an advantageous configuration, the distance d between the line of action of the maximum force F of the stabilizer on the metal strip 200 and the air outlet gap 112 lies in a range from 100 to 800 mm, preferably in a range from 100 to 550 mm or further preferably in a range from 100 to 450 mm.

The blow-off device 110 spans a slot 122, through which the metal strip 200 is guided. The blow-off device is used to blow off excess coating material from the surface of the metal strip 200.

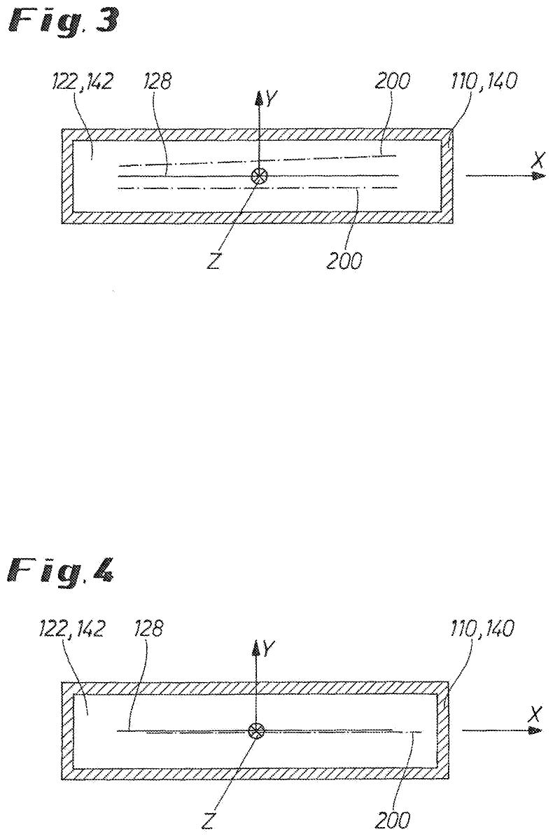

To ensure that the blow-off on the top and bottom sides of the metal strip 200 is uniform, it is important that the metal strip 200 passes through the slot 122 of the blow-off device 110 in a specified target center position, also known as the center plane 160 or the fitting line reference position, as symbolized in FIG. 3 in the form of the continuous line in the X direction. This target center position is characterized in particular by uniform distances or distance distributions to the inner edges of slot 122 of the blow-off device 110. In addition to the desired target center position 128, FIG. 3 also shows possible undesired actual positions of the metal strip as dashed lines. For example, undesired actual layers for the metal strip 200 consist of the fact that it is twisted in relation to the target center layer or shifted parallel in the Y direction.

FIG. 4 shows a third possible undesired actual position, in which the metal strip 200 is shifted parallel to the target center position in the X-direction; that is, in the width direction.

On its part, the electromagnetic stabilizer 140 has a slot 142 through which the metal strip 200 is also guided. Here as well, the metal strip 200 passes through the slot 142, preferably in a predetermined target center position 160, as shown in FIGS. 3 and 4. This is achieved by ensuring that the forces provided by the magnets of the 140 electromagnetic stabilizer act in a suitable manner on the metal strip 200. The same applies to slot 142 and the target center position pursued there, as before with reference to FIGS. 3 and 4 for the slot 122 of the blow-off device 110.

A first detection device 154 for detecting a deviation of the actual position of the metal strip 200 from a predetermined target center position in the slot 122 of the blow-off device 110 is further arranged between the stabilizer 140 and the blow-off device 110. Alternatively, the first detection device 154 can be formed to detect only the actual position of the metal strip. A regulating device 180 is also provided to regulate the actual position of the metal strip 200 to the specified target center position 128 in the slot 122 of the blow-off device, as explained above with reference to FIGS. 3 and 4. This regulation can be effected a) by displacing the blow-off device 110 with the aid of a blow-off displacement device 115 and/or b) by displacing the traverse 130, on which the blow-off device 110 is suspended, with the aid of an upright displacement device 158. The regulation takes place in response to the detected deviation from the actual position to the target position. If the deviation of the actual position from the target center position is not determined in the first detection device 154, it can also be determined, for example, within the regulating device 180. The blow-off device 110 is displaced in a horizontal plane transverse to the transport direction R of the metal strip in accordance with the detected deviation of the actual position of the metal strip from the specified target center position in the slot 122 of the blow-off device. In other words: If it is determined that the metal strip 200 does not pass through the slot 122 in the target center position 128, the blow-off device 110 is displaced by the blow-off displacement device 115 in such a manner that the metal strip passes through the slot 122 of the blow-off device once again into the target center position 128. For this purpose, the first detection device 154 is formed in such a manner that it can preferably detect all three actual positions of the metal strip 200 deviating from the target center position 128 as described above with reference to FIGS. 3 and 4.

The specified displacement of the blow-off device 110 is not to affect the electromagnetic stabilizer 140. For this purpose, the control device 170 is formed to control the stabilization displacement device 145 of the individual magnets 144 in such a manner that, in the event of a displacement of the blow-off device 110 with respect to a fitting line reference position, the electromagnetic stabilizer 140 is not moved with it, but can remain at its original position. The stabilizer 140 and the blow-off device 110 are decoupled from each other. That is, they can be moved independently from each other and relative to each other by their respective displacement devices 145, 115. The fitting line reference position 160 designates a fixed defined center plane of the apparatus. In contrast, the target center positions 128 refer to slots 122, 142. The control device 170 therefore acts on the stabilizing displacement devices 145 in such a manner that, in the event of the displacement of the blow-off device 110, the electrical stabilizers 140 preferably makes the exact opposite movement to that of the blow-off device 110; that is, as a result, it preferably remains in its original position.

In order to realize this special type of control for the stabilizer displacement devices 145, the control device 170 is able to evaluate different situations. On the one hand, the control device 170 can be formed to carry out the displacement of the electromagnetic stabilizer 140 or the individual magnets 144 in accordance with the deviation of the actual position of the metal strip from the predetermined target center position of the metal strip in the slot 122 of the blow-off device 110 detected by the first detection device 154.

Alternatively or in addition, the control device 170 can be formed to carry out the displacement of the electromagnetic stabilizer 140 or the individual magnets 144 as required and in the opposite direction to the displacement of the blow-off device 120 detected by a second detection device 155. The second detection device 155 serves to detect the displacement of the blow-off device 110 in relation to a fitting line reference position 160 of the apparatus 100.

Finally, according to an additional alternative or as a supplement, the control device 170 can be formed to cause the displacement of the electromagnetic stabilizer 140 and the individual magnets 144, respectively, in accordance with a detected deviation of the actual position of the metal strip from a predetermined target center position in the slot 142 of the electromagnetic stabilizer. A prerequisite for this is that a third detection device 156 is provided for detecting the specified deviation of the actual position of the metal strip from the predetermined target center position in the slot 142 of the electromagnetic stabilizer 140. Preferably, each magnet 144 is assigned with such a third detection device 156 as a distance sensor. Preferably, such sensors are arranged in the pot magnets. For example, they work optically or with the aid of induced eddy currents.

Each of the first, second and third detection devices 154, 155, 156 is formed to detect preferably all conceivable deviations of an actual position of the metal strip from the desired target center position. These include in particular a (parallel) displacement of the metal strip in the x or y direction or a twist, as explained above with reference to FIGS. 3 and 4. Accordingly, the stabilizing and blow-off displacement devices 145, 115—with suitable actuation by the regulating device 180 or the control device 170—are formed to move the blow-off device 110 and the electromagnetic stabilizer 140 in the horizontal plane transversely to the transport direction R of the metal strip in any manner, in particular to displace them (in a parallel direction) or to rotate them around a vertical axis of rotation, in order to realize the passing through of the metal strip into the target center position.

The first and third detection devices 154, 156 and optionally also the second detection device 155 can be realized in the form of one or more optical sensor devices 190. In this respect, the sensor device forms a structural unit for the specified detection devices. Preferably, one sensor device 190 per coil is provided in the electromagnetic stabilizer 140. The measured values of all sensor devices are typically averaged. The sensor device 190 can also be generally referred to as a distance detection device.

If a deviation of the actual position from the target position of the metal strip is detected within the electromagnetic stabilizer 140, in particular with the aid of the third detection device 156, the actual position to the target position or on the fitting line is regulated with the aid of the control 170 through suitable individual variation of the currents through the coils in the magnets 144.

### LIST OF REFERENCE SIGNS

100 Apparatus

110 Blow-off device

112 Air outlet gap

115 Blow-off displacement device

122 Slot of the blow-off device

128 Target center level

130 Traverse

140 Stabilizer

142 Slot of the stabilizer

144 Magnet

145 Stabilizer displacement device

150 Side upright

154 First detection device

155 Second detection device

156 Third detection device (=distance sensor)

158 Upright displacement device

160 Fitting line reference position of the apparatus

170 Control device

180 Regulating device

190 Sensor device

200 Metal strip

300 Coating container

310 Coating material

A Fixed side

B Loose side

d Distance

F Force

L Longitudinal axis blow-off device

R Transport direction of the metal strip

X Width direction of the metal strip in the target center position

Y Direction transverse to the plane spanned by the metal strip

1.-12. (canceled)

13. An apparatus for treating a metal strip after it has exited from a coating container with a liquid coating material, comprising:
a blow-off device arranged above the coating container, the blow-off device having an air outlet gap for blowing off excess parts of the liquid coating material from a surface of the metal strip after the metal strip has passed through the coating container; and
an electromagnetic stabilizer arranged above the blow-off device having a plurality of magnets for stabilizing the metal strip after leaving the coating container and the blow-off device,
wherein at least some of the magnets of the stabilizer are pot magnets with pot coils.

14. The apparatus according to claim 13,
wherein all magnets of the electromagnetic stabilizer are pot magnets.

15. The apparatus according to claim 13,
further comprising a horizontal traverse mounted between two vertical side uprights,
wherein the blow-off device is fastened to and suspended below the traverse, and
wherein the electromagnetic stabilizer is arranged between the traverse and the blow-off device and fastened to and suspended from the traverse independently of the blow-off device.

16. The apparatus according to claim 13,
wherein the electromagnetic stabilizer is arranged above the blow-off device in such a manner that a distance between a line of action of a maximum force of the electromagnetic stabilizer on the metal strip and the air outlet gap is in a range of 100-800 mm.

17. The apparatus according to claim 13,
wherein each magnet is assigned a distance sensor for a continuous detection of a distance of the respective magnet from the metal strip.

18. The apparatus according to claim 17,
wherein the distance sensor is arranged in the middle of the pot coil.

19. The apparatus according to claim 17,
further comprising a regulating device for controlling a position of the metal strip in a slot of the electromagnetic stabilizer to a predetermined target center position in accordance with the distances between the magnets and the metal strip determined by the distance sensors of the magnets through the suitable variation of a current through the coils of the magnets.

20. The apparatus according to claim 15,
further comprising a displacement device individually assigned to each of the magnets, by which the respective magnet is mounted on the traverse in a displaceable manner relative to the traverse.

21. The apparatus according to claim 20,
wherein the displacement device is formed to displace the magnet assigned to it in a width direction of the metal strip.

22. The apparatus according to claim 13,
further comprising a collision protection device for retracting the electromagnetic stabilizer in a direction perpendicular to a plane of the metal strip.

23. The apparatus according to claim 13,
wherein the blow-off device has an air gap for both sides of the metal strip.

24. The apparatus according to claim 13,
the magnets of the electromagnetic stabilizer are arranged on both sides of the metal strip.
